(19) United States
(12) Patent Application Publication
(10) Pub. No.: US 2026/0154554 A1
(43) Pub. Date: Jun. 4, 2026

(54) METHOD OF TRAINING ARTIFICIAL INTELLIGENCE MODELS USING NOISY LABELED SAMPLES AND APPARATUS THEREFOR

(71) Applicant: RESEARCH & BUSINESS FOUNDATION SUNGKYUNKWAN UNIVERSITY, Suwon-si (KR)

(72) Inventors: Jee-Hyong LEE, Seoul (KR); Jin Seop LEE, Suwon-si (KR); Noo-Ri KIM, Osan-si (KR)

(21) Appl. No.: 19/404,978

(22) Filed: Dec. 1, 2025

(30) Foreign Application Priority Data
Dec. 2, 2024 (KR) 10-2024-0176345

(51) Int. Cl. G06N 3/0895

(52) U.S. Cl. CPC G06N 3/0895

(57) ABSTRACT

Disclosed is a technology for training artificial intelligence models using noisy labeled samples. More particularly, a method by which a training apparatus according to an embodiment of the present specification trains artificial intelligence models includes: relabeling samples through the artificial intelligence models, and selecting samples to be used for training from among the relabeled samples as first samples; extracting a structural label for each of the samples based on a relationship between the sample and other samples; and calculating a loss based on the first samples and the structural label.

### CROSS-REFERENCE TO RELATED APPLICATION

This application claims priority to Korean Patent Application No. 10-2024-0176345, filed on Dec. 2, 2024 in the Korean Intellectual Property Office, the disclosure of which is incorporated herein by reference.

### BACKGROUND OF THE DISCLOSURE

### Field of the Disclosure

The present specification relates to learning with noisy labels, and more particularly, to a training method capable of enabling reliable model training even in a data environment including noise by considering structural information between samples, and an apparatus for implementing the same.

### Description of the Related Art

Data including noisy labels has a problem that commonly occurs in the training process of machine learning and deep learning models, and this can degrade the training accuracy of the model. In particular, when label errors exist in a dataset, the model can learn incorrect training patterns, which can result in poor generalization performance. To solve this, various approaches have been proposed, such as a filtering method that filters out unreliable data, a method using a noise-robust loss function, and a data augmentation technique. However, existing techniques mostly have a limitation in that they excessively rely on the initial predictions of the model or selectively utilize only reliable data, failing to sufficiently reflect the entire dataset. Furthermore, in modeling complex data distributions, existing statistics-based methods often fail to perform effective training because they cannot reflect structural relationships.

### SUMMARY OF THE DISCLOSURE

Existing deep learning models show high performance by training on large-scale datasets. However, labeling these datasets is costly, and datasets labeled by semi-automatic or crowdsourcing methods inevitably include noisy labels. When training is performed with data including noisy labels, a problem arises in that the model overfits to the noisy labels, thereby degrading generalization performance.

To solve such problems, methods of learning with noisy labels have been developed, but existing methods of learning with noisy labels still have a problem in that generalization performance is degraded by noise, as they heavily rely on the predictions of the training model itself. In addition, existing methods have a problem in that they fail to accurately detect noise as they rely on low-reliability prediction results in the initial training stage of the model, or they have low data utilization by using only reliable data for training, and they have a limitation in that simple statistical methods cannot sufficiently represent nonlinear and complex data structures, leading to degraded generalization performance.

In accordance with an aspect of the present disclosure, the above and other objects can be accomplished by the provision of a training method according to a second embodiment by which a training apparatus for artificial intelligence models trains the artificial intelligence models using noisy labeled samples, the training method comprising: relabeling samples through the artificial intelligence models, and selecting samples to be used for training from among the relabeled samples as first samples; extracting a structural label for each of the samples based on a relationship between the sample and other samples; and calculating a loss based on the first samples and the structural label. Here, the structural label may be a soft label generated based on a feature similarity between one sample and its surrounding samples.

The extracting of the structural label may comprise: obtaining a class distribution for the samples by predicting a class, to which each of the samples belongs, according to a result of relabeling the samples; calculating a feature similarity between the samples based on the class distribution; selecting, by each of the samples, surrounding samples by a preset number according to an order of high feature similarity with itself, recording, for each of the samples, the number of times it was selected by surrounding samples and classes of the selected surrounding samples; and extracting the structural label by calculating, for each of the samples, a probability that the sample belongs to a specific class for each class, based on the recorded result. Here, the feature similarity may be calculated through cosine similarity. The preset number may be set in a range of 10 or more and 40 or less.

The calculating of the loss may comprise: augmenting the samples using the structural label, and applying Mixup to the augmented samples; and calculating a loss based on the structural label by calculating a cross-entropy loss based on the Mixup-applied samples.

The calculating of the loss may comprise: augmenting the samples using the first samples, and applying Mixup to the augmented samples; calculating a loss based on the first samples by calculating a cross-entropy loss based on the Mixup-applied samples; and calculating a final loss by combining the loss based on the structural label and the loss based on the first samples.

The selecting of the samples may comprise: distinguishing noisy labeled samples from among the samples based on a preset threshold; relabeling the noisy labeled samples; and selecting the first samples from among the relabeled samples based on k-Nearest Neighbor (k-NN).

In accordance with another aspect of the present disclosure, there is provided a computer-readable recording medium according to a second embodiment, wherein the computer-readable recording medium stores a program for executing the training method according the first embodiment of the present disclosure.

In accordance with yet another aspect of the present disclosure, there is provided a training apparatus according to a third embodiment comprising: at least one processor for driving a training program that trains artificial intelligence models using noisy labeled samples.

The training program may relabel samples through the artificial intelligence models, and select samples to be used for training from among the relabeled samples as first samples; extract a structural label for each of the samples based on a relationship between the sample and other samples; and calculate a loss based on the first samples and the structural label. Here, the structural label may be a soft label generated based on a feature similarity between one sample and its surrounding samples.

The training program may obtain a class distribution for the samples by predicting a class, to which each of the samples belongs, according to a result of relabeling the samples; calculate a feature similarity between the samples based on the class distribution; select, by each of the samples, surrounding samples by a preset number according to an order of high feature similarity with itself, record, for each of the samples, the number of times it was selected by surrounding samples and classes of the selected surrounding samples; and extract the structural label by calculating, for each of the samples, a probability that the sample belongs to a specific class for each class, based on the recorded result.

The training program may calculate the feature similarity using cosine similarity.

The training program may set the preset number in a range of 10 or more and 40 or less.

The training program may augment the samples using the structural label, and apply Mixup to the augmented samples; and calculate a loss based on the structural label by calculating a cross-entropy loss based on the Mixup-applied samples.

The training program may augment the samples using the first samples, and apply Mixup to the augmented samples; calculate a loss based on the first samples by calculating a cross-entropy loss based on the Mixup-applied samples; and calculate a final loss by combining the loss based on the structural label and the loss based on the first samples.

The training program may distinguish noisy labeled samples from among the samples based on a preset threshold; relabel the noisy labeled samples; and select the first samples from among the relabeled samples based on k-Nearest Neighbor (k-NN).

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a flowchart illustrating a method by which a training apparatus according to an embodiment of the present specification trains artificial intelligence models using noisy labeled samples, according to a chronological order;

FIG. 2 is a flowchart illustrating a specific example of a process of relabeling samples and selecting first samples through artificial intelligence models, according to a chronological order;

FIG. 3 is a flowchart illustrating a specific example of a process of extracting a structural label, according to a chronological order;

FIG. 4 is a diagram illustrating an algorithm for extracting a structural label;

FIG. 5 is a diagram illustrating accuracy according to the number of surrounding samples to be selected when a sample selects surrounding samples based on feature similarity between samples, in the process of extracting structural labels;

FIG. 6 is a diagram illustrating an overall algorithm for training a model using structural labels;

FIG. 7 illustrates experimental results dependent upon a noisy label ratio of the training apparatus according to an embodiment of the present specification and other methods;

FIG. 8A and FIG. 8B are a diagram comparing the logit distribution of a general SSR method and the training method according to an embodiment of the present specification; and

FIG. 9 is a block diagram illustrating the training apparatus according to an embodiment of the present specification.

### DETAILED DESCRIPTION OF THE DISCLOSURE

Hereinafter, embodiments of the present specification will be described in detail with reference to the drawings. However, in the following description and the accompanying drawings, detailed descriptions of known functions or configurations that may obscure the gist of the embodiments will be omitted. In addition, throughout the specification, ‘comprising’ a certain element means that it further includes other elements, not excluding other elements, unless otherwise stated.

The terms used in the present specification are used to explain a specific exemplary embodiment and not to limit the present inventive concept. Thus, the expression of singularity in the present specification includes the expression of plurality unless clearly specified otherwise in context. Also, terms such as “include” or “comprise” in this application should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Unless otherwise defined specifically, all terms (including technical and scientific terms) used herein have the same meaning as commonly understood by one of ordinary skill in the art to which this specification belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

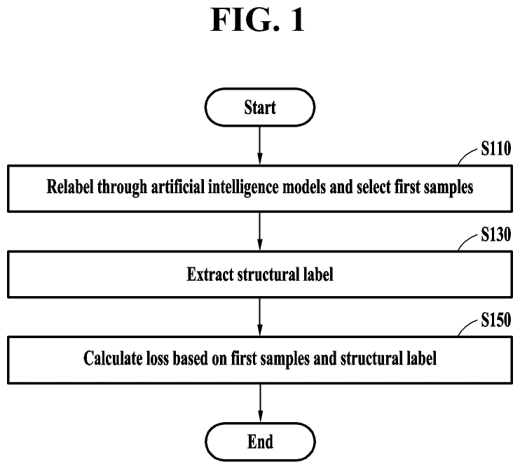

FIG. 1 is a flowchart illustrating a method by which a training apparatus according to an embodiment of the present specification trains artificial intelligence models using noisy labeled samples, according to a chronological order.

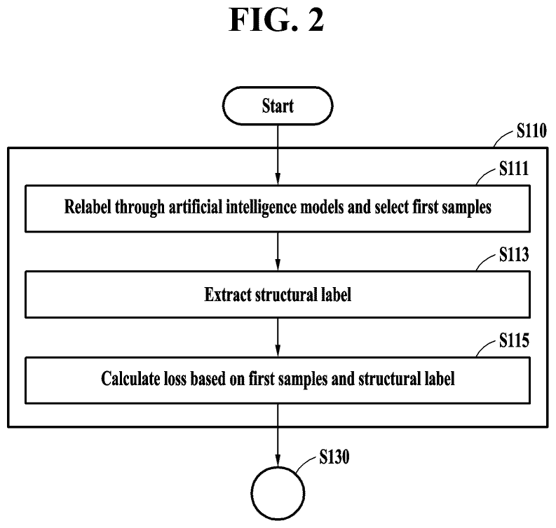

Referring to FIG. 1, in step S110, the training apparatus may relabel samples through the artificial intelligence models to be trained, and select samples to be used for training from among the relabeled samples as first samples. For a specific description of step S110 of selecting samples to be used for training as the first samples, reference is briefly made to FIG. 2.

FIG. 2 is a flowchart illustrating a specific example of a process of relabeling samples and selecting first samples through artificial intelligence models, according to a chronological order.

Referring to FIG. 2, in step S111, the training apparatus may distinguish noisy labeled samples from among the samples based on a preset threshold.

In step S113, the training apparatus may relabel the noisy labeled samples. Here, the training apparatus may relabel the noisy labeled samples according to Equation 1 below:

$${y}_{i}^{r} = \{ \begin{matrix}arg {max}_{l} f ( α ( {x}_{i} ) ) , & if {max}_{l} f ( α ( {x}_{i} ) ) > {𝒯}_{r} \\ {y}_{i} , & otherwise\end{matrix} \qquad [ Equation 1 ]$$

where α denotes weak-augmentation, [symbol] denotes a relabeling threshold, and

$${y}_{i}^{r}$$

denotes the label of a sample for which relabeling is completed.

In step S115, the training apparatus may select the first samples from among the relabeled samples based on k-Nearest Neighbor (k-NN).

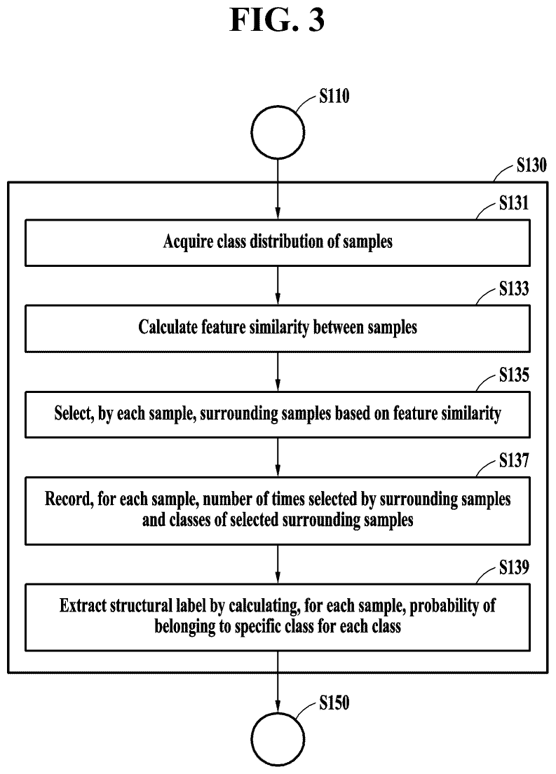

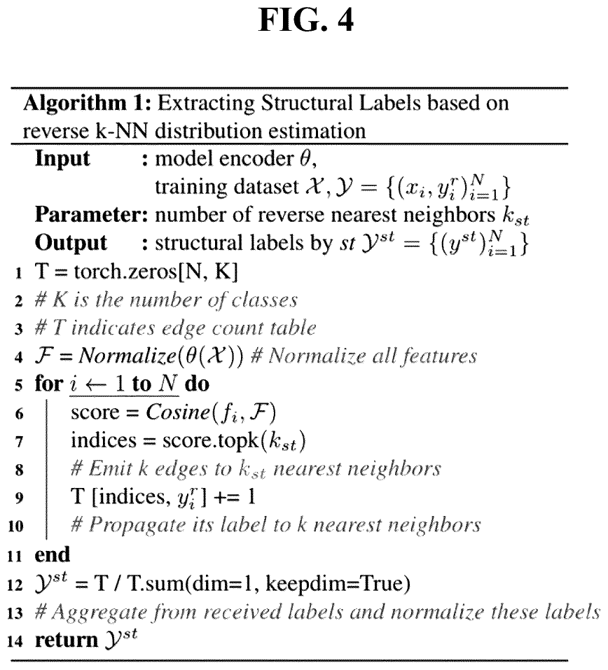

Referring back to FIG. 1, in step S130, the training apparatus may extract a structural label for each of the samples based on a relationship between the sample and other samples. Here, the structural label signifies a soft label generated based on a feature similarity between one sample and its surrounding samples, and the soft label signifies a label expressed as a continuous value including the probability that the sample belongs to each class. For example, for a certain sample x, the soft label of x may be expressed as [0.7, 0.2, 0.1] when the probabilities that x belongs to classes a, b, and c are 0.7, 0.2, and 0.1, respectively. For a description of step S130 in which the training apparatus extracts the structural label, reference is briefly made to FIGS. 3 and 4.

FIG. 3 is a flowchart illustrating a specific example of a process of extracting a structural label, according to a chronological order. FIG. 4 is a diagram illustrating an algorithm for extracting a structural label.

Referring to FIG. 3, in step S131, the training apparatus may obtain a class distribution for the samples by predicting a class, to which each of the samples belongs, according to a result of relabeling the samples.

In step S133, the training apparatus may calculate a feature similarity between the samples based on the class distribution.

The training apparatus according to an embodiment may calculate the feature similarity using cosine similarity.

In step S135, the training apparatus may select, for each of the samples, surrounding samples by a preset number according to an order of high feature similarity with itself.

In step S137, the training apparatus may record, for each of the samples, the number of times it was selected by surrounding samples and classes of the selected surrounding samples.

In step S139, the training apparatus may extract the structural label by calculating, for each of the samples, a probability that the sample belongs to a specific class for each class, based on the recorded result.

The training apparatus according to an embodiment may estimate the probability that a specific sample will appear for a given class, based on reverse k-NN and feature similarity.

Specifically, from each sample predicted as class C, an arrow is shot to the closest samples to that sample. In other words, each sample predicted as class C may select k samples closest to that sample. Here, the k closest samples may also include the sample itself.

The probability P(x|c) that sample x will appear for the given class C may be expressed by the following equation:

$$P ( x \vert c ) = \frac{\# of {Arrows}_{x , c}}{k \cdot \vert {X}^{c} \vert} \qquad [ Equation 2 ]$$

where #of Arrows_{x,c} denotes the total number of arrows received by sample x from samples predicted as class C, i.e., the number of times sample x was selected by surrounding samples.

If x is located in a dense region of samples predicted as class C, it receives a large number of arrows, and if it is located in a region where there are few samples predicted as class C, it receives a small number of arrows.

Therefore, P(x|c) may be calculated by dividing #of Arrows_{x,c} by the total number of arrows originating from samples predicted as class C.

Based on the class distribution of the samples, the structural label of sample x may be defined by obtaining the probability P(c|x) that class C is given for sample x.

$$P ( c \vert x ) = \frac{P ( x \vert c ) P ( c )}{{\sum }_{c ∈ C} P ( x \vert c ) P ( c )} \qquad [ Equation 3 ]$$

where P(c) denotes the probability that class C will be observed, which may be determined from the number of samples in each class as shown in the following equation:

$$P ( c ) = \frac{\vert {X}^{c} \vert}{{\sum }_{c = 1}^{C} \vert {X}^{c} \vert} \qquad [ Equation 4 ]$$

According to Equation 4, Equation 3 may be reformulated as the following equation:

$$P ( c \vert x ) = \frac{P ( x \vert c ) \vert {X}^{c} \vert}{{\sum }_{c = 1}^{C} P ( x \vert c ) \vert {X}^{c} \vert} \qquad [ Equation 5 ]$$

From Equations 2 and 5, P(c|x) may be represented by the following equation:

$$P ( c \vert x ) = \frac{\# of {Arrows}_{x , c}}{{\sum }_{c = 1}^{C} \# of {Arrows}_{x , c}} \qquad [ Equation 6 ]$$

An algorithm illustrating the process of extracting the structural label is shown in FIG. 4.

Referring to line 6 of FIG. 4, it may be confirmed that the training apparatus calculates the feature similarity between the samples using cosine similarity. In line 7, it may be confirmed that the training apparatus causes each of the samples to select surrounding samples by a preset number kₛₜ according to an order of high feature similarity with itself.

Referring to line 14 of FIG. 4, a process of finally returning for the training apparatus the structural label y^{st} as a result, thereby extracting it, is shown.

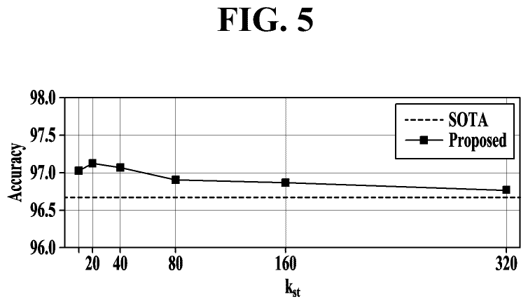

Assuming that there is uniform noise in the sample space, in Equation 6 is free from uniform noise, and even if the noise is not uniform, it may be easily smoothed by using a sufficiently large kₛₜ. Here, kₛₜ denotes the number of reverse nearest neighbors used in reverse k-NN, and signifies the preset number in step S135. However, if kₛₜ is too large, the number of arrows received from samples of classes other than class C increases, which may lead to excessive smoothing of the structural label, resulting in the loss of structural information containing correlations such as feature similarity between samples. Therefore, an appropriate kₛₜ value needs to be selected to avoid excessive dilution of structural information. The accuracy of the artificial intelligence models according to the kₛₜ value, i.e., the preset number, is shown in FIG. 5.

FIG. 5 is a diagram illustrating accuracy according to the number of surrounding samples to be selected when a sample selects surrounding samples based on feature similarity between samples, in the process of extracting structural labels.

Referring to FIG. 5, it may be seen that the accuracy of the model is high when the preset number, the kₛₜ value, is 10 or more and 40 or less. In particular, when the kₛₜ value is 20, the performance of the model was confirmed to be the best. Accordingly, in the training apparatus according to an embodiment, the preset number may be set in a range of 10 or more and 40 or less, or may be set to 20.

Referring back to FIG. 1, in step S150, the training apparatus may calculate a loss based on the first samples and the structural label.

Here, the training apparatus according to an embodiment may calculate a loss based on the structural label by augmenting the samples using the structural label, applying Mixup to the augmented samples, and calculating a cross-entropy loss based on the Mixup-applied samples.

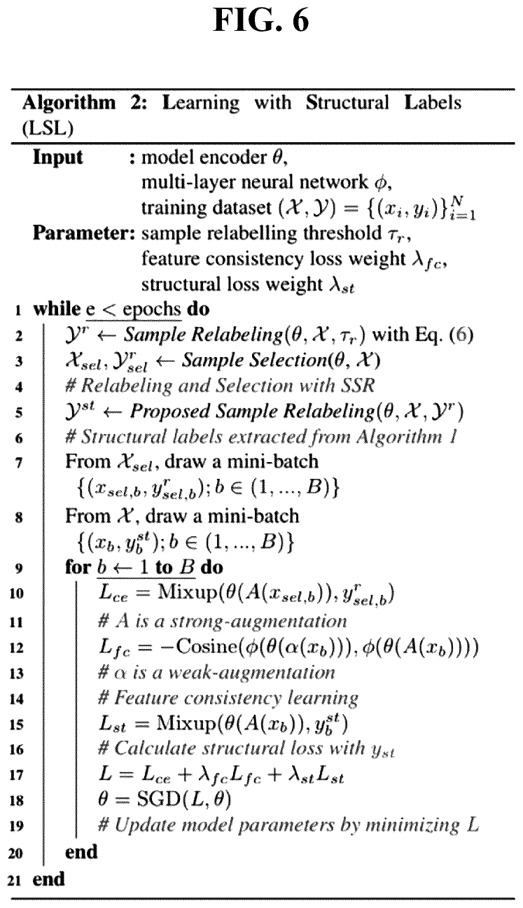

Further, the training apparatus according to an embodiment may calculate a loss based on the first samples and the structural label, by augmenting the samples using the first samples, applying Mixup to the augmented samples, calculating a loss based on the first samples by calculating a cross-entropy loss based on the Mixup-applied samples, and calculating a final loss by combining the loss based on the structural label and the loss based on the first sample. A more specific description of step S150 of calculating the loss will be supplemented in FIG. 6.

FIG. 6 is a diagram illustrating an overall algorithm for training a model using structural labels.

Referring to lines 2 and 3 of FIG. 6, a process is shown in which the training apparatus according to an embodiment generates a refined label γ^{r} by relabeling samples based on Equation 1 through the artificial intelligence models to be trained, and selects samples (i.e., the first samples) xₛₑₗ to be used for training and the label

$${y}_{sel}^{r}$$

of the sample. Here, the relabeling of samples and the selection of the first sample may be performed through a sample selection and relabeling (SSR) method. The selected samples are samples that are clean enough for the artificial intelligence models to trust, i.e., samples that do not include noisy labels, and thus are used when the training apparatus trains the artificial intelligence models.

Referring to line 5 of FIG. 6, it may be confirmed that the training apparatus extracts the structural label y^{sl} from the samples. The structural label y^{sl} is a structural label extracted through the algorithm of FIG. 4.

From lines 9 to 20 of FIG. 6, the process by which the training apparatus calculates the loss may be confirmed.

Specifically, the training apparatus may augment the sample x_{b} through strong-augmentation, and calculate the loss Lₛₜ based on the structural label by applying Mixup to the augmented samples and the structural label y^{st} and calculating the cross-entropy loss.

Further, the training apparatus may augment the sample (i.e., the first sample) x_{sel,b} selected by the artificial intelligence models in line 3 of FIG. 6, through strong-augmentation, and calculate the loss L_{ce} based on the first sample by applying Mixup to the augmented samples and the label

$${y}_{sel , b}^{r}$$

of x_{sel,b} and calculating the cross-entropy loss.

Additionally, the training apparatus may calculate the loss L_{fc} that reflects the feature consistency of the sample by calculating the cosine similarity between the result of augmenting the sample x_{b} through weak-augmentation and the result of augmenting the sample x_{b} through strong-augmentation.

Next, the training apparatus may calculate the final loss L to be used for training the artificial intelligence models by combining the loss Lₛₜ based on the structural label, the loss L_{ce} based on the first sample, and the loss L_{fc} reflecting the feature consistency of the sample.

Here, λ_{fc} and λₛₜ denote the loss weight reflecting feature consistency and the loss weight based on the structural label, respectively.

Finally, the training apparatus trains the artificial intelligence models by updating the parameters of the artificial intelligence models in a way that minimizes the final loss L through Stochastic Gradient Descent (SGD).

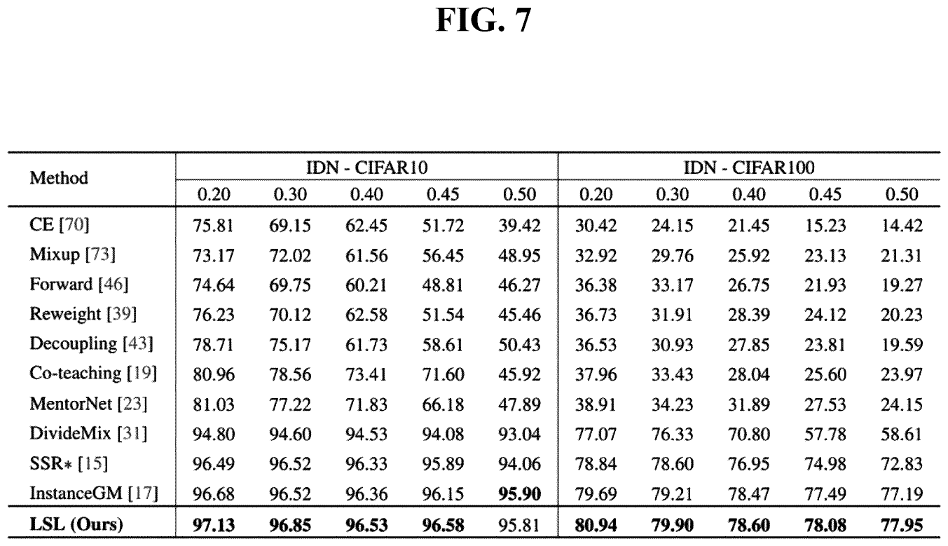

FIG. 7 illustrates experimental results dependent upon a noisy label ratio of the training apparatus according to an embodiment of the present specification and other methods.

“CIFAR10” and “CIFAR100” in FIG. 7 signify datasets. Each includes 50,000 training images and 10,000 test images, and each image has dimensions of 32×32×3. “IDN” in FIG. 7 signifies that the experiment was conducted in an instance-dependent noise (IDN) environment. “0.20” to “0.50” displayed at the bottom of the “IDN-CIFAR10” and “IDN-CIFAR100” datasets in FIG. 7 signify noise ratios, respectively.

From FIG. 7, the experimental results comparing the accuracy of the Learning with Structural Labels (LSL) method, which is the training method according to an embodiment, and various other methods can be confirmed, and the portion recording the highest accuracy is emphasized in bold. Through these experimental results, it can be confirmed that the performance of the training method according to the embodiment shows the best performance at most noise ratios.

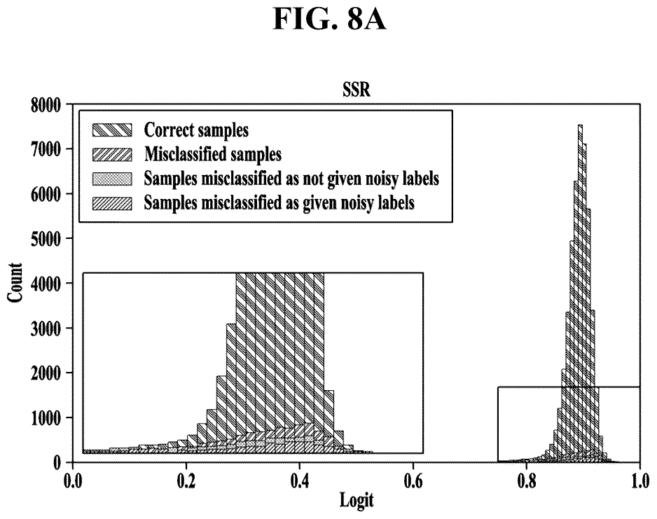

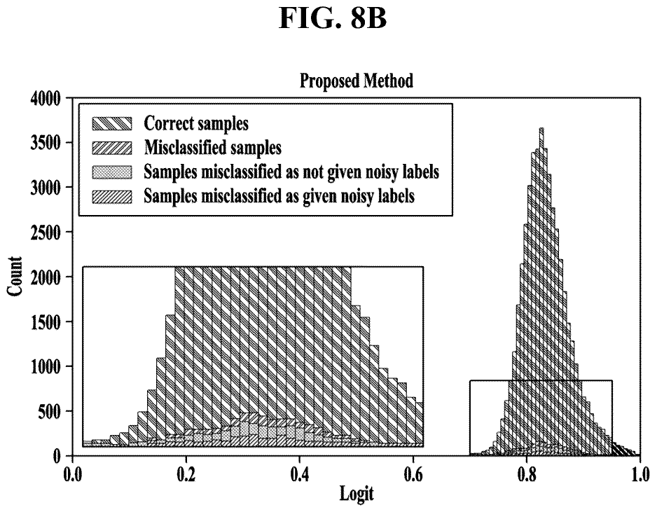

FIG. 8A and FIG. 8B are a diagram comparing the logit distribution of a general SSR method and the training method according to an embodiment of the present specification, and shows the results of an experiment conducted under IDN conditions with a noise ratio of 0.50 on the CIFAR10 dataset.

Referring to part of FIG. 8A, in the case of the general SSR method, it can be confirmed that the total number of samples misclassified in class is 3238, and 1248 samples, corresponding to 39% of these, are misclassified as the given noisy label.

On the other hand, referring to part of FIG. 8B, it can be confirmed that when the training method according to the embodiment is used, the total number of misclassified samples is 2107, and 646 samples, corresponding to 31% of these, are misclassified as the given noisy labels. Through this, it can be seen that the training method according to the embodiment not only has a smaller total number of misclassified samples, but also has a lower ratio of samples misclassified as the given noisy label.

Furthermore, comparing parts of FIG. 8A and FIG. 8B, it can be confirmed that in the general SSR method, the logit distribution of samples misclassified according to the given noisy labels (red part) is skewed to the right compared to the logit distribution of misclassified samples (orange part), whereas this phenomenon does not appear in the case of the training method according to the embodiment. Through this, it can be seen that the training method according to the embodiment better prevents the phenomenon of overfitting to the given noisy labels and shows better generalization performance, compared to the general SSR method.

Meanwhile, a computer-readable recording medium according to an embodiment of the present specification may store a program for executing the training method according to an embodiment of the present specification on a computer. The computer-readable recording medium includes all kinds of recording devices in which data readable by a computer system is stored.

Examples of the computer-readable recording medium include ROM, RAM, CD-ROM, magnetic tape, floppy disk, optical data storage device, and the like. Further, the computer-readable recording medium may be distributed in computer systems connected over a network, so that computer-readable code may be stored and executed in a distributed manner.

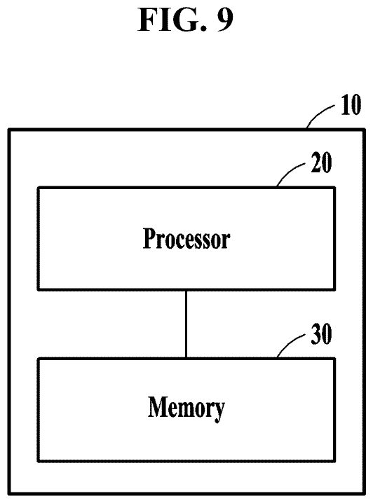

FIG. 9 is a block diagram illustrating the training apparatus according to an embodiment of the present specification, which is a reconfiguration of the training method of FIG. 1 according to the embodiment of the present specification from the perspective of hardware configuration, and only an outline of the operation and function of each component will be briefly described to avoid redundancy in description.

Referring to FIG. 9, a training apparatus 10 may comprise at least one processor 20 for driving a training program that trains artificial intelligence models using noisy labeled samples. Here, the training apparatus 10 may further comprise a memory 30 for storing the training program, and the processor 20 and the memory 30 may be electrically connected, either directly or indirectly.

In the processor 20, the training program may relabel samples through the artificial intelligence models, select samples to be used for training from among the relabeled samples as first samples, extract a structural label for each of the samples based on a relationship between the sample and other samples, and calculate a loss based on the first samples and the structural label. Here, the structural label may be a soft label generated based on a feature similarity between one sample and its surrounding samples.

In the processor 20, the training program may obtain a class distribution for the samples by predicting a class, to which each of the samples belongs, according to a result of relabeling the samples, calculate a feature similarity between the samples based on the class distribution, select, by each of the samples, surrounding samples by a preset number according to an order of high feature similarity with itself, record, for each of the samples, the number of times it was selected by surrounding samples and classes of the selected surrounding samples, and extract the structural label by calculating, for each of the samples, a probability that the sample belongs to a specific class for each class, based on the recorded result.

In the processor 20, the training program may calculate the feature similarity using cosine similarity.

In the processor 20, the training program may set the preset number in a range of 10 or more and 40 or less.

In the processor 20, the training program may augment the samples using the structural label, apply Mixup to the augmented samples, and calculate a loss based on the structural label by calculating a cross-entropy loss based on the Mixup-applied samples.

In the processor 20, the training program may augment the samples using the first samples, apply Mixup to the augmented samples, calculate a loss based on the first samples by calculating a cross-entropy loss based on the Mixup-applied samples, and calculate a final loss by combining the loss based on the structural label and the loss based on the first samples.

In the processor 20, the training program may distinguish noisy labeled samples from among the samples based on a preset threshold, relabel the noisy labeled samples, and select the first samples from among the relabeled samples based on k-NN.

The invention according to an embodiment of the present specification can effectively learn the characteristics of data even in a data environment including noise by defining a structural label that reflects the structural relationship between samples. In particular, it can overcome the limitations of existing methods by estimating sample distribution based on reverse k-NN to reflect even complex data structures. Furthermore, by combining with a data augmentation technique, it can enhance the generalization performance of the model while minimizing the influence of noise, and can contribute to providing reliable training results even in a noisy labels environment.

### DESCRIPTION OF SYMBOLS

10: training apparatus
20: processor
30: memory

### STATEMENT REGARDING PRIOR DISCLOSURES BY THE INVENTOR OR A JOINT INVENTOR

The inventors of the present application have made related disclosure in Noo-ri Kim et. al., “Learning with Structural Labels for Learning with Noisy Labels,” IFEE/CVF Conference on Computer Vision and Pattern Recognition on Jun. 21, 2024. The related disclosure was made less than one year before the effective filing date (Dec. 2, 2024) of the present application, and the inventors of the present application are the same as those of the related disclosure. Accordingly, it is apparent that the related disclosure is a grace period inventor disclosure and, thus the related disclosure is disqualified as prior art under 35 USC 102(a)(1) against the present application. See 35 USC 102(b)(1)(A) and MPEP 2153.01(a).

What is claimed is:

1. A training method by which a training apparatus for artificial intelligence models trains the artificial intelligence models using noisy labeled samples, the training method comprising:
relabeling samples through the artificial intelligence models, and selecting samples to be used for training from among the relabeled samples as first samples;
extracting a structural label for each of the samples based on a relationship between the sample and other samples; and
calculating a loss based on the first samples and the structural label,
wherein the structural label is a soft label generated based on a feature similarity between one sample and its surrounding samples.

2. The training method according to claim 1, wherein the extracting of the structural label comprises:
obtaining a class distribution for the samples by predicting a class, to which each of the samples belongs, according to a result of relabeling the samples;
calculating a feature similarity between the samples based on the class distribution;
selecting, by each of the samples, surrounding samples by a preset number according to an order of high feature similarity with itself;
recording, for each of the samples, the number of times it was selected by surrounding samples and classes of the selected surrounding samples; and
extracting the structural label by calculating, for each of the samples, a probability that the sample belongs to a specific class for each class, based on the recorded result.

3. The training method according to claim 2, wherein the feature similarity is calculated through cosine similarity.

4. The training method according to claim 2, wherein the preset number is set in a range of 10 or more and 40 or less.

5. The training method according to claim 1, wherein the calculating of the loss comprises:
augmenting the samples using the structural label, and applying Mixup to the augmented samples; and
calculating a loss based on the structural label by calculating a cross-entropy loss based on the Mixup-applied samples.

6. The training method according to claim 5, wherein the calculating of the loss comprises:
augmenting the samples using the first samples, and applying Mixup to the augmented samples;
calculating a loss based on the first samples by calculating a cross-entropy loss based on the Mixup-applied samples; and
calculating a final loss by combining the loss based on the structural label and the loss based on the first samples.

7. The training method according to claim 1, wherein the selecting of the samples comprises:
distinguishing noisy labeled samples from among the samples based on a preset threshold;
relabeling the noisy labeled samples; and
selecting the first samples from among the relabeled samples based on k-Nearest Neighbor (k-NN).

8. A computer-readable recording medium storing a program for executing the training method of claim 1 on a computer.

9. A training apparatus comprising:
at least one processor for driving a training program that trains artificial intelligence models using noisy labeled samples,
wherein the training program relabels samples through the artificial intelligence models, and selects samples to be used for training from among the relabeled samples as first samples; extracts a structural label for each of the samples based on a relationship between the sample and other samples; and calculates a loss based on the first samples and the structural label,
wherein the structural label is a soft label generated based on a feature similarity between one sample and its surrounding samples.

10. The training apparatus according to claim 9, wherein the training program obtains a class distribution for the samples by predicting a class, to which each of the samples belongs, according to a result of relabeling the samples; calculates a feature similarity between the samples based on the class distribution; selects, by each of the samples, surrounding samples by a preset number according to an order of high feature similarity with itself; records, for each of the samples, the number of times it was selected by surrounding samples and classes of the selected surrounding samples; and extracts the structural label by calculating, for each of the samples, a probability that the sample belongs to a specific class for each class, based on the recorded result.

11. The training apparatus according to claim 10, wherein the training program calculates the feature similarity using cosine similarity.

12. The training apparatus according to claim 10, wherein the training program sets the preset number in a range of 10 or more and 40 or less.

13. The training apparatus according to claim 9, wherein the training program augments the samples using the structural label, and applies Mixup to the augmented samples; and calculates a loss based on the structural label by calculating a cross-entropy loss based on the Mixup-applied samples.

14. The training apparatus according to claim 13, wherein the training program augments the samples using the first samples, and applies Mixup to the augmented samples; calculates a loss based on the first samples by calculating a cross-entropy loss based on the Mixup-applied samples; and calculates a final loss by combining the loss based on the structural label and the loss based on the first samples.

15. The training apparatus according to claim 9, wherein the training program distinguishes noisy labeled samples from among the samples based on a preset threshold; relabels the noisy labeled samples; and selects the first samples from among the relabeled samples based on k-Nearest Neighbor (k-NN).
